(19) United States
(12) Patent Application Publication
(10) Pub. No.: US 2009/0022834 A1
(43) Pub. Date: Jan. 22, 2009

(54) Craft tool for making three-dimensional illustrated cards

(76) Inventor: Teng-Kuei Chen, Taipei (TW)

Correspondence Address: Hershkovitz & Associates, LLC, 2845 Duke Street, Alexandria, VA, 22314, US

(21) Appl. No.: 11/826,659

(22) Filed: Jul. 17, 2007

(51) Int. Cl. B29C 53/02

(52) U.S. Cl. 425/87

(57) ABSTRACT

A craft tool for making an illustrated card has a body with a drive bar having a stamp, a cover and a stopper. The cover is mounted around the proximal end of the body and has a base having an elongated slot and a pipe cleaner slot. The elongated slot is formed in the top of the base. The pipe cleaner slot is formed in the bottom of the base perpendicular to the elongated slot, and allows the stamp to pass through the pipe cleaner slot and a bent pipe cleaner to be mounted completely inside. The stopper is attached to the base, has a flat bottom that can be positioned flush to the illustrated card and allows the bent pipe cleaner to be pushed into the illustrated card accurately.

### BACKGROUND OF THE INVENTION

1. Field of Invention

The present invention relates to a craft tool, and more particularly to a craft tool that is handled easily to make a three-dimensional illustrated card.

2. Description of the Related Art

With reference to FIGS. 7 and 8, U.S. application Ser. No. 11/119,777 discloses a three-dimensional illustrated card (50) that has a base (51), a printed ink layer (52) and multiple pipe cleaners (53). The printed ink layer (52) is applied to the base (51) and has at least one colored pattern and character. The pipe cleaners (53) are attached to a front surface of the printed ink layer (52) on the base (51) and correspond respectively to parts of the at least one pattern and character. Each pipe cleaner (53) is colored, can be bent to U-shaped and has two ends. The ends pierce the printed ink layer (52) to allow the pipe cleaner (53) to be attached securely to the printed ink layer on the base to form the three-dimensional illustrated card (50).

With further reference to FIG. 9, U.S. application Ser. No. 11/119,314 discloses a tool for bending the pipe cleaners (53) conveniently and attaching the pipe cleaners (53) to the print ink layer (52) easily. The tool set comprises a die mold (60) and a conventional craft tool (70).

With further reference to FIG. 10, the die mold (60) has a top edge, two notches (62) and a through hole (61) defined vertically through the die mold (60). The notches (62) are defined in the top edge to be mount around the ends of the pipe cleaner (53).

With further reference to FIG. 11, the craft tool (70) has two ends, a bending die (71) with an alignment notch (711) in one end and a clamp (72) with a clamping notch (721) on the other end. The bending die (71) will push a central part of the pipe cleaner (53) into the through hole (61) to bend the pipe cleaner (53) to be U-shaped. The clamping notch (721) of the clamp (72) is mounted around the central part of the pipe cleaner (53), so the ends of the pipe cleaner (53) protrude from the clamp (72). Thus, a person can hold the craft tool (70) to allow the ends of the pipe cleaner (53) to pierce into the printed ink layer (52).

However, the ends of the pipe cleaner (53) protrude from the clamp (72), so the ends may be deformed before they pierce into the printed ink layer (52). Moreover, when the person, frequently a child, holds the craft tool (70), they are not sure whether the craft tool (70) is perpendicular to the printed ink layer (52) or not. If the craft tool (70) is not perpendicular to the printed ink layer (52), the ends of the pipe cleaner (53) may be bent out of shape and cannot pierce into the printed ink layer (52), so the person must replace the pipe cleaner (53).

To overcome the shortcomings, the present invention provides a tool for making three-dimensional illustrated card to mitigate or obviate the aforementioned.

### SUMMARY OF THE INVENTION

The primary objective of the present invention is to provide a craft tool that is easily handled to make three-dimensional illustrated cards.

To achieve the objective, the craft tool for making illustrated cards in accordance with the present invention has a body, a cover and a stopper. The body has drive bar having a stamp. The cover is mounted around the proximal end of the body and has a base. The base is has an elongated hole and a pipe cleaner slot. The elongated hole is formed in the top of the base. The pipe cleaner slot is formed in the bottom of the base, perpendicular to the elongated slot and allows the stamp to pass through the pipe cleaner slot and a bent pipe cleaner to be mounted completely inside. The stopper is attached to the base, has a flat bottom that can be positioned flush to the illustrated card and allows the bent pipe cleaner to be pushed into the illustrated card accurately.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view with a cover in phantom lines of a craft tool for making an illustrated card in accordance with the present invention;

FIG. 2 is a partially exploded perspective view of the craft tool for making the illustrated card in FIG. 1;

FIG. 3 is an exploded perspective view of the craft tool for making the illustrated card in FIG. 1; FIG. 4 is a perspective view in partial section of a cover of the craft tool for making the illustrated card in FIG. 1;

FIG. 5 is a bottom view of the craft tool for making the illustrated card in FIG. 1;

FIG. 6 is an exploded perspective view of the craft tool with a bending die without an alignment notch;

FIG. 7 is an operational perspective view of a conventional craft tool in accordance with the prior art being used with an illustrated card;

FIG. 8 is a cross sectional side view of the illustrated card in FIG. 7, showing bent pipe cleaners mounted on the illustrated card;

FIG. 9 is an operational side view of the conventional tool in FIG. 7 being used to bend a pipe cleaner with a die mold;

FIG. 10 is a perspective view of the die mold in FIG. 9; and

FIG. 11 is a perspective view of the conventional craft tool in FIG. 9.

### DETAILED DESCRIPTION OF THE INVENTION

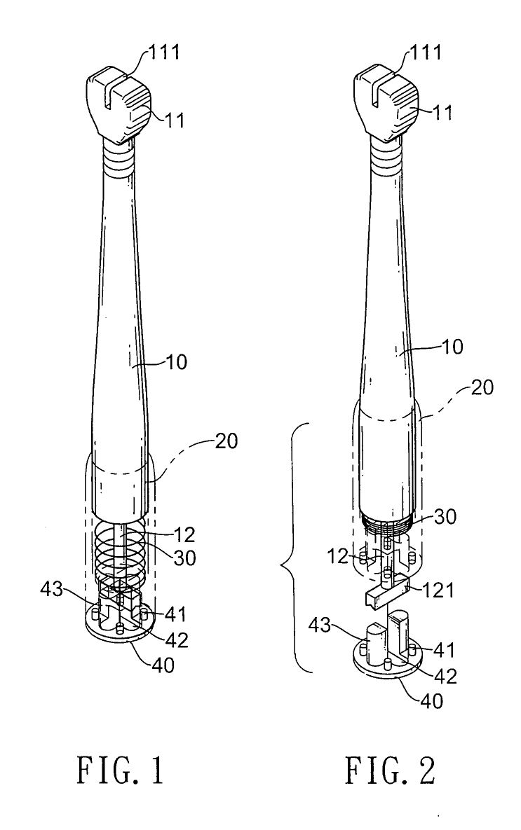

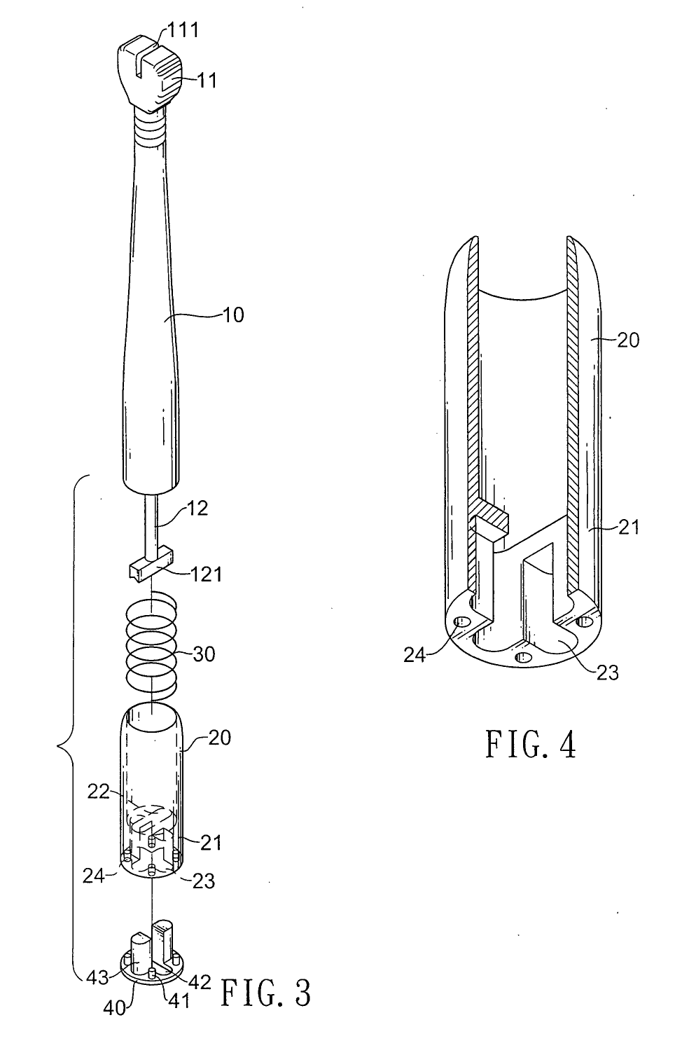

With reference to FIGS. 1, 2 and 3, a craft tool for making illustrated cards in accordance with the present invention that is used to manipulate a pipe cleaner and has a body (10), a cover (20), a spring (30) and a stopper (40).

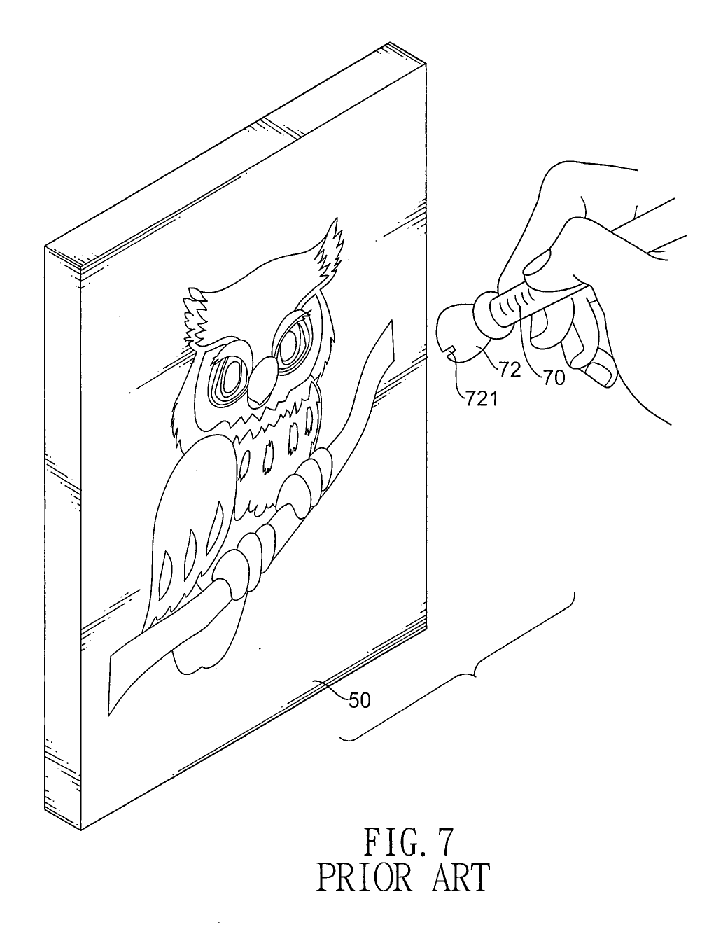

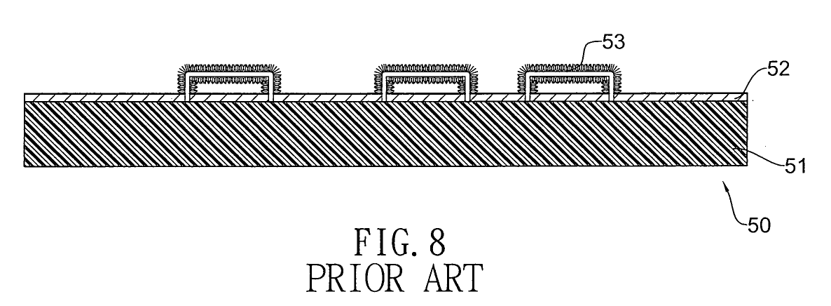

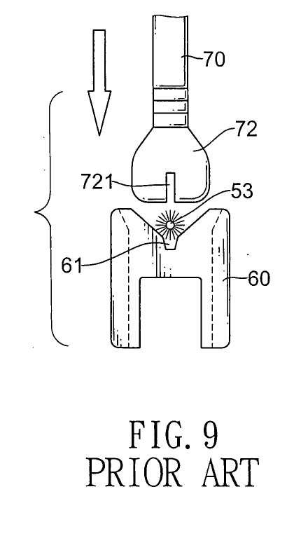

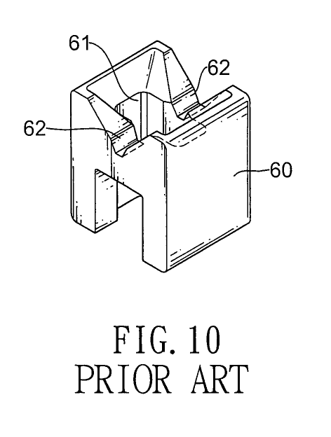

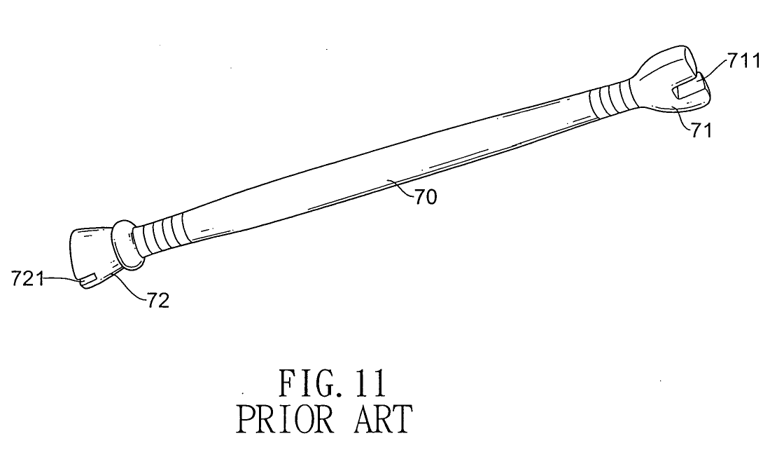

With further reference to FIG. 6, the body (10) is a rod and has a distal end, a proximal end, a bending die (11) and a drive bar (12).

The bending die (11) is operated with a die mold, protrudes from the distal end of the body (10), has an end and may have an alignment notch (111). The alignment notch (111) is formed in the end of the bending die (11) to hold the pipe cleaner and allows the pipe cleaner to be bent to a bent pipe cleaner.

The drive bar (12) protrudes from the proximal end and has an end and a stamp (121). The stamp (121) is mounted perpendicularly on the end of the drive bar (12) to push bent pipe cleaners into illustrated cards.

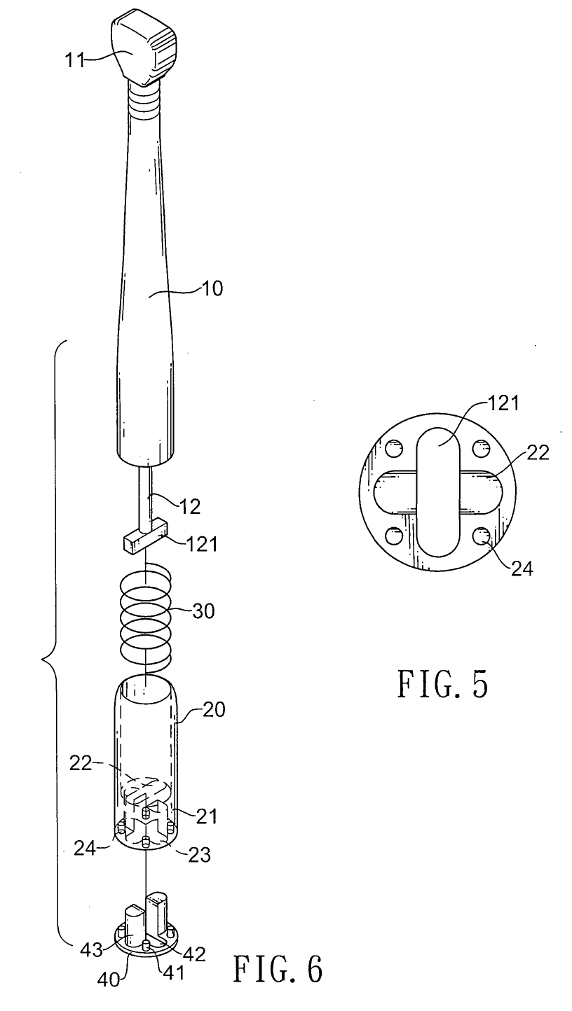

With further reference to FIGS. 4 and 5, the cover (20) may be cylindrical, is mounted around the proximal end of the body (10) and the stamp (121) and has a top opening and a base (21). The base (21) may be cylindrical, is formed below the top opening and has a top, a bottom, an elongated slot (22), a pipe cleaner slot (23) and multiple positioning recesses (24). The elongated slot (22) is defined longitudinally through the base (21), communicates with the top opening and is mounted slidably around the drive bar (12). The pipe cleaner slot (23) is defined longitudinally in the bottom of the base (21), perpendicularly intersects and communicates with the elongated slot (22) and is mounted slidably around the stamp (121). The pipe cleaner slot (23) allows the bent pipe cleaner to be mounted in the pipe cleaner slot (23), is parallel to the stamp (121) and holds the bent pipe cleaner perpendicular to the illustrated card whilst the stamp (121) pushes the bent pipe cleaner into the illustrated card. The positioning recesses (24) are formed in the bottom of the base (21).

The spring (30) is mounted in top opening in the cover (20), around the drive bar (121) and between the proximal end of the body (10) and the top of the base (21) and biases the stamp (121) to return to a default position after pushing the pipe cleaner.

The stopper (40) corresponds to and is attached to the base (21) and has an upper surface, a bottom surface, an exit hole (42), multiple positioning protrusions (41) and two limiting protrusions (43). The bottom surface is flat. The exit hole (42) is defined through the stopper (40), aligns with the pipe cleaner slot (23), is perpendicular to the elongated slot (22) and allows the bent pipe cleaner to pass through. The positioning protrusions (41) are formed on and protrude from the upper surface of the stopper (40) and correspond respectively to and are mounted respectively in the positioning recesses (24) to hold the stopper (40) to the bottom of the base (21). The limiting protrusions (43) are formed on and protrude from the upper surface of the stopper (40) and are mounted in the elongated slot (22) to partially block the elongated slot (22) and form a channel that communicates with the exit hole (42).

Because the pipe cleaner slot (23) allows all of the bent pipe cleaner to be mounted inside, the bent pipe cleaner does not protrude from the craft tool and can be aligned perpendicular to the illustrated card whilst the bottom of the stopper (40) is flush with the illustrated card and prevents the pipe cleaner from being deformed. Therefore a person can control and handle the craft tool more effectively to facilitate making of the three-dimensional illustrated card.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A craft tool for making an illustrated card comprising
a body being a rod and having
a distal end;
a proximal end;
a drive bar protruding from the proximal end and having an end and a stamp mounted perpendicularly on the end of the drive bar;
a cover mounted around the proximal end of the body and the stamp and having
a top opening; and
a base formed below the top opening and having
a top;
a bottom; and
an elongated slot defined longitudinally through the base, communicating with the top opening and mounted slidably around the drive bar; and
a pipe cleaner slot defined longitudinally in the bottom of the base, perpendicularly intersecting and communicating with the elongated slot and mounted slidably around the stamp;
a stopper corresponding to and being attached to the bottom of the base and having
an upper surface;
a bottom surface being flat;
an exit hole being defined through the stopper, aligning with the pipe cleaner slot, being perpendicular to the elongated slot and allowing a bent pipe cleaner to pass through; and
two limiting protrusions being formed on and protruding from the upper surface of the stopper and being mounted in the elongated slot to partially block up the elongated slot and forming a channel that communicates with the exit hole.

2. The craft tool for making an illustrated card as claimed in claim 1 further comprising a spring mounted in the top opening in the cover, around the drive bar and between the proximal end of the body and the top of the base.

3. The craft tool for making an illustrated card as claimed in claim 1, wherein
the base further has multiple positioning recesses formed in the bottom of the base;
the stopper further has multiple positioning protrusions being formed on and protruding from the upper surface of the stopper, corresponding respectively to and mounted respectively in the positioning recesses to hold the stopper to the bottom of the base.

4. The craft tool for making an illustrated card as claimed in claim 1, wherein the body further has a bending die protruding from the distal end of the body.

5. The craft tool for making an illustrated card as claimed in claim 4, wherein the bending die further has an alignment notch formed in the end of the bending die.

6. The craft tool for making an illustrated card as claimed in claim 1, wherein the cover and the base are cylindrical.
